(19) United States
(12) Patent Application Publication
(10) Pub. No.: US 2009/0074258 A1
(43) Pub. Date: Mar. 19, 2009

(54) Systems and methods for facial recognition

(76) Inventor: James Cotgreave, Smithtown, NY (US)

Correspondence Address: Thomas M. Galgano, 20 W. Park Avenue, Suite 204, Long Beach, NY, 11561, US

(21) Appl. No.: 11/901,830

(22) Filed: Sep. 19, 2007

(51) Int. Cl. G06K 9/00

(52) U.S. Cl. 382/118

(57) ABSTRACT

Different colored rectangles are used to identify and categorize each of several faces in a single photograph. For example, red rectangles highlight faces which are unidentified and green rectangles highlight faces which have been identified. Alternatively identification and characterization are indicated via a mouseover block of text. The invention allows for user input to identify selected faces and to tag selected faces as not interested, e.g. color the rectangle grey. The invention has utility in many facial recognition applications. For example, in a security application green rectangles can be used to indicate faces belonging to authorized personnel and blue rectangles can be used to indicate faces belonging to known criminals while red rectangles indicate unidentified faces. In a casino application, green rectangles can be used to indicate faces belonging to valued customers while blue rectangles can be used to indicate faces of known card counters.

### BACKGROUND OF THE INVENTION

1. Field of the Invention

This invention relates broadly to facial recognition systems. More particularly, this invention relates to an enhancement for facial recognition systems.

2. State of the Art

Facial recognition systems utilize a database and a comparison algorithm to compare digital representations of human faces. The facial recognition algorithm identifies “nodal points” such as the distance between the eyes, the width of the nose, the shape of the cheekbones, the length of the jaw line, etc. These nodal points are measured and a numeric code called a “faceprint” is stored in the database and linked to the photo from which they were obtained.

Facial recognition systems have many applications, most of them related to security. For example a database of known criminals and their photos is often used in facial recognition systems to compare a photo of a suspect to the photos of known criminals. Facial recognition systems are also used in access control. A person seeking access must show their face to a video camera to be compared to a database of faceprints of people with authority to gain access. Access can be entry to building, crossing a border, access to a machine, access to information, etc. My co-pending application entitled “SYSTEMS AND METHODS FOR FACIAL RECOGNITION”, Ser. No. _______, filed Sep. 5, 2007, the complete disclosure of which is incorporated by reference herein, uses facial recognition in a social networking environment.

### SUMMARY OF THE INVENTION

The present invention addresses issues which arise when a facial recognition system is presented with a photograph that contains multiple faces. Many modern facial recognition systems will automatically detect the presence of multiple faces, highlight each face with a rectangle, and attempt to find matches for all of the faces detected. The present invention presents systems and methods for identifying and categorizing recognized and unrecognized faces contained in a single photograph.

According to the invention, different colored rectangles are used to identify and categorize each of several faces in a single photograph. For example, red rectangles highlight faces which are unidentified and green rectangles highlight faces which have been identified. According to the presently preferred embodiment, green rectangles highlight faces which have been identified and are members of a selected category whereas blue rectangles highlight faces which have been identified but which are not members of the selected category. The invention allows for user input to identify selected faces and to tag selected faces as not interested, e.g. color the rectangle grey.

As an alternative to colored rectangles, a mouseover indication is employed. When a user moves the mouse pointer into the rectangle, a block of text appears indicating whether or not the face is recognized, and, if recognized some information about the person associated with the face

The invention has utility in many facial recognition applications. For example, in a security application green rectangles can be used to indicate faces belonging to authorized personnel and blue rectangles can be used to indicate faces belonging to known criminals while red rectangles indicate unidentified faces. In a casino application, green rectangles can be used to indicate faces belonging to valued customers while blue rectangles can be used to indicate faces of known card counters.

Additional objects and advantages of the invention will become apparent to those skilled in the art upon reference to the detailed description taken in conjunction with the provided figures.

### BRIEF DESCRIPTION OF THE DRAWINGS

FIG. 1 is a high level flow chart illustrating a generalized application of the methods of the invention;

FIG. 2 is a high level flow chart illustrating a specialized application of the methods of the invention;

FIGS. 3-5A are exemplary screen shots illustrating the user interface to systems of the invention employing the methods of FIG. 2; and

FIG. 6 is a high level block diagram of a system according to the invention.

### DETAILED DESCRIPTION

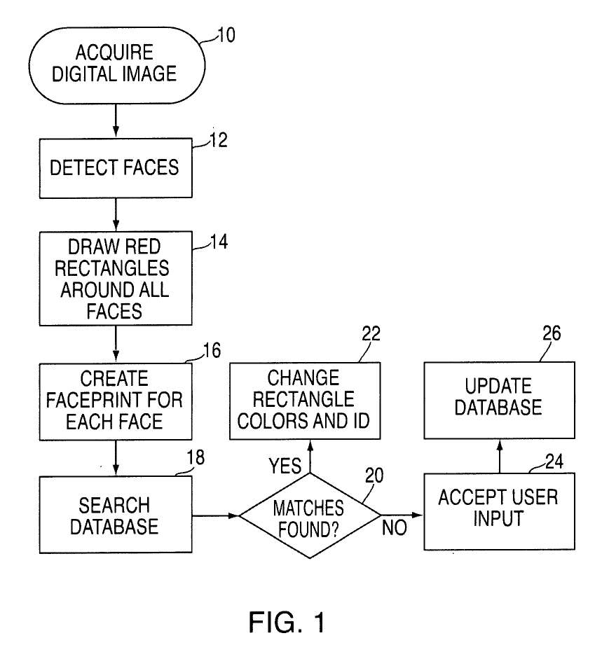

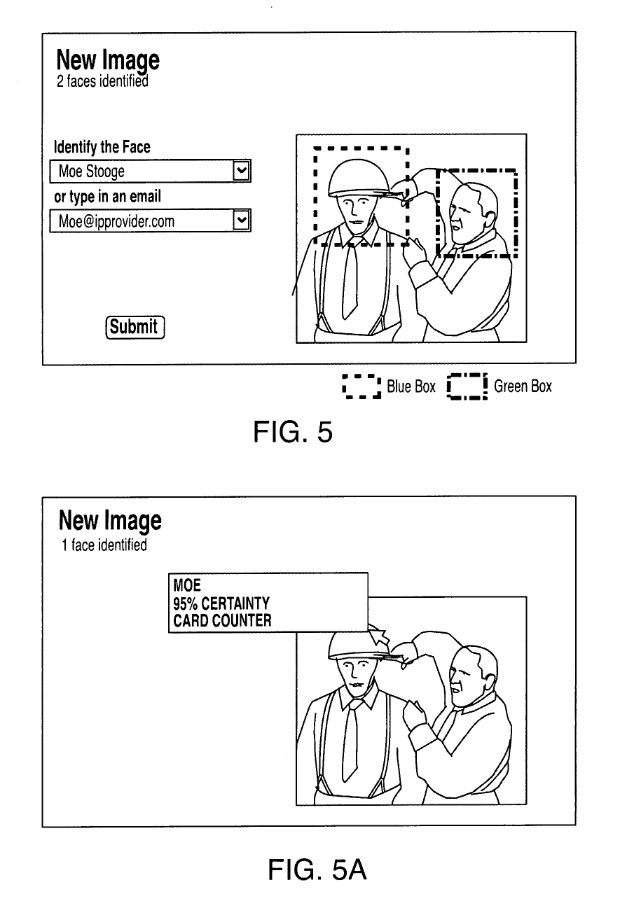

Turning now to FIG. 1; a generalized representation of the methods of the invention begins at 10 by acquiring a digital image. This acquisition is typically accomplished with a video camera, uploading an image file from a digital camera, or scanning a hard copy photograph. Once the facial recognition software has acquired the image, faces in the image are detected and located at 12. The system displays the image with red rectangles highlighting the faces at 14. See also FIG. 3. Having identified the locations of faces in the image, the facial recognition software creates a faceprint of each face at 16 and searches the database for matching faceprints at 18. Optionally, user input can be accepted to allow the user to restrict the search to a subset of the database. For example, in the case of a social networking application, the search could be restricted to friends or to people other than friends. At 20 it is determined whether one or more matches have been found. If one or more matches were found at 20, the system changes the display at 22 to indicate green rectangles around the faces recognized and to display identifying information about the recognized face. If no matches were found at 20, the system accepts user input at 24 to identify the face(s) and updates the database at 26 to include the new identified faceprint(s). As an alternative to colored rectangles, the rectangles can be all the same color and mouseover text blocks can be used to convey information about the face in the rectangle. FIG. 5A shows an example of mouseover text which indicates the identity of the face (Moe), the certainty of the identification (95%), and the fact that Moe is a card counter.

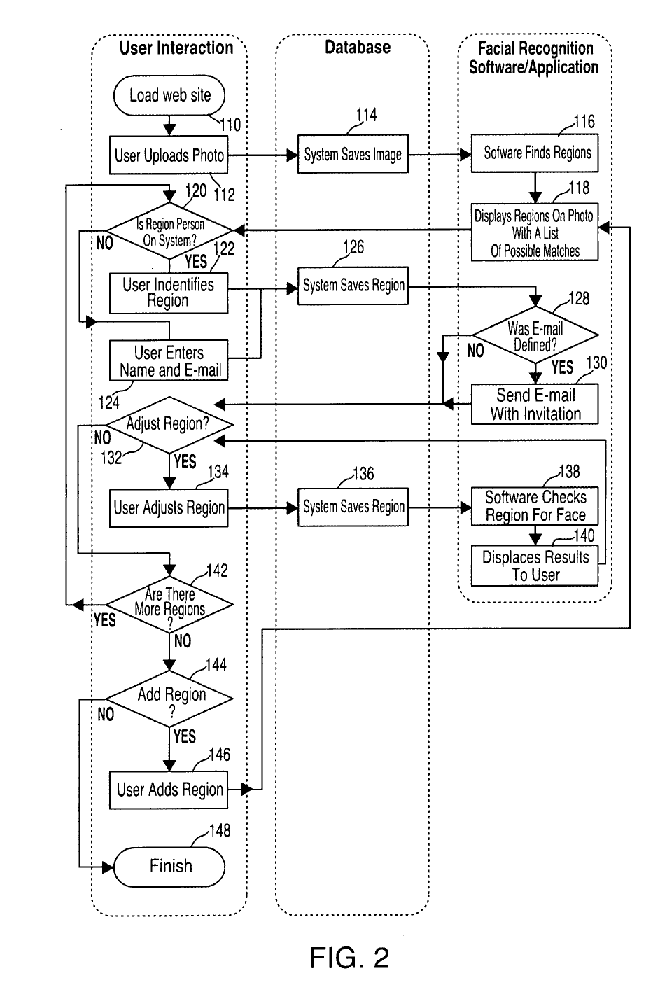

A system and method of the type described above can be applied to the facial recognition social networking system of previously incorporated Ser. No. ______, filed Sep. 5, 2007. FIGS. 2-5 illustrate the systems and methods as applied to the social networking system.

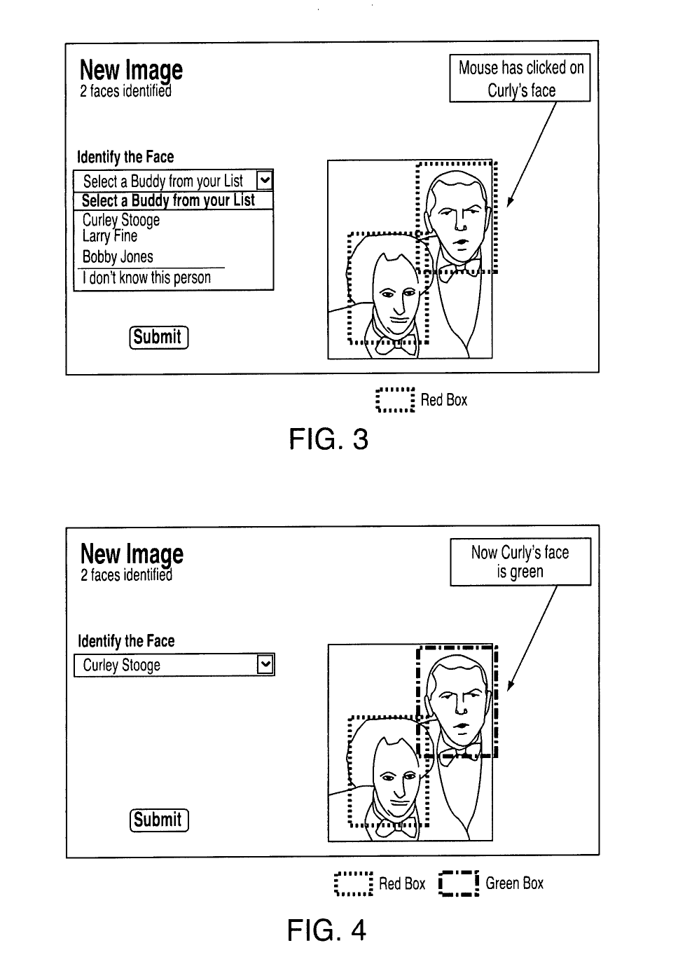

Referring now to FIG. 2, the member loads the website at 110 by entering a URL or selecting a bookmark in a web browser. Alternatively, the system may be locally stored and accessed without resort to the internet. The member then uploads a photo at 112 to the system. The system saves the image in a database at 114. At 116, the facial recognition software finds regions of the photo which contain faces and attempts to find matches for the faces. At 118, the photo is displayed with the regions identified in red rectangles and with a list of possible database matches. This is illustrated in. FIG. 3 where the solid line rectangles indicate red rectangles which indicate unknown or uncertain identity. If the list of possible identities includes the identity of a face in the photo as determined by the user at 120, user selects a region of the photo by mouse clicking on it and selects the appropriate identity from the list at 122. This is shown in FIG. 4 with the member's name selected on the left and the rectangle around the member's face now changed to green.

If the photo contains a face that does not match any of the names in the list presented in FIG. 3, but the member knows the name of the of the person and, optionally, their email, the member enters the identity and email address at 124. This is shown in FIG. 5. In both cases (identity selected from pull down menu or manually entered), the system stores the identified region and identity information in the database at 126. The system then determines at 128 whether an email address was included. If there was, an email invitation is sent at 130 to the person asking them to confirm the identity of the face in the region.

At 132, the member is given the opportunity to adjust the current region on the photo. If the member chooses, the region is adjusted at 134 and the image of the region is saved by the system in the database at 136. The system attempts to recognize the face in the region at 138 and displays a list of possible matches at 140. If, as determined by the member at 132, no more adjustment is needed, the member can select at 142 to return to 120 and identify the face in the adjusted region. At 144, the member has the option of manually selecting a region to be identified and can enter a new region at 146 after which the process returns to 118 with the display indicating the selected region and a list of possible matching identities. Otherwise, the member finishes at 148.

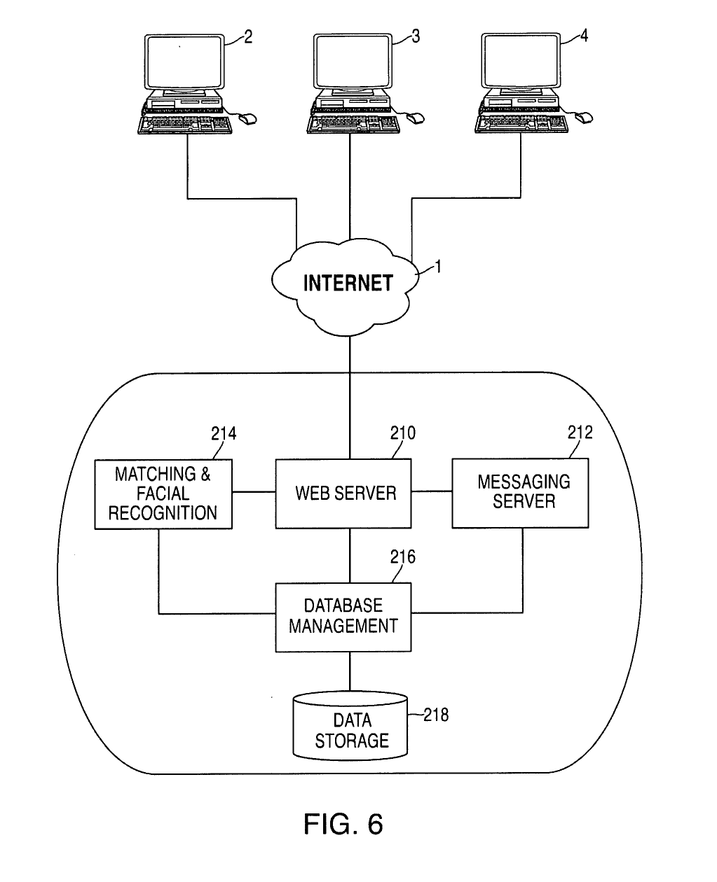

Turning now to FIG. 6, a system according to the invention includes a web server 210 coupled to the internet 1. The web server 210 is also coupled to a messaging server 212, matching and facial recognition software 214, and database management software 216. The database management software 216 communicates with data storage 218 and provides information to the matching and facial recognition software 214 as well as the web server 210. The messaging server 212 stores and retrieves messages in the data storage 218 via the database management software 216. As illustrated in FIG. 6, a plurality of member computers (or internet devices), e.g. 2, 3, 4, are connect to the system via the internet 1. The system illustrated in FIG. 1 is greatly simplified. Those skilled in the art will appreciated that the web server in a large system sill likely comprise many web servers which are selected via a load balancer depending on the number of members being logged on at the same time.

There have been described and illustrated herein several embodiments of systems and methods for facial recognition. While particular embodiments of the invention have been described, it is not intended that the invention be limited thereto, as it is intended that the invention be as broad in scope as the art will allow and that the specification be read likewise. Thus, while particular colors have been specified, it will be appreciated that other colors could be used so long as the significance of each color is established. In addition, while rectangles have been disclosed for identifying regions of a photograph, it will be understood that other bounding shapes can be used. For example, and not by way of limitation, polygons, circles and other shapes could work as well as rectangles. It will also be appreciated that in many applications, it may not be necessary to involve the internet and that the entire system may be implemented locally. It will therefore be appreciated by those skilled in the art that yet other modifications could be made to the provided invention without deviating from its spirit and scope as claimed.

What is claimed is:

1. A method for categorizing each of several faces in a single photograph using facial recognition software, said method comprising:
locating each of a plurality of faces in a single photograph;
creating a faceprint for each face located;
comparing the faceprints to a database of faceprints;
displaying the photograph with a bounding shape associated with each face in the photograph; and
indicating whether or not the faceprint for the associated shape matched a faceprint in the database.

2. A method according to claim 1, wherein:
the indicating whether or not the faceprint for the associated face matched a faceprint in the database is by the color of the bounding shape.

3. A method according to claim 1, wherein:
the indicating whether or not the faceprint for the associated face matched a faceprint in the database is by a block of text.

4. A method according to claim 3, wherein:
the block of text appears only when a mouse pointer is within the bounding shape.

5. A method according to claim 1, further comprising:
indicating a characteristic of the persons associated with faceprints which matched faceprints in the database.

6. A method according to claim 1, wherein:
the indicating a characteristic is by a block of text.

7. A method according to claim 6, wherein:
the block of text appears only when a mouse pointer is within the bounding shape.

8. A method according to claim 5, wherein:
the characteristic is whether the persons are authorized access.

9. A method according to claim 5, wherein:
the characteristic is whether the persons are criminals.

10. A method according to claim 5, wherein:
the characteristic is whether the persons are valued customers.

11. A method according to claim 5, wherein:
the characteristic is whether the persons are card counters.

12. A method according to claim 1, further comprising:
accepting input regarding the identity of one or more faces in the photograph which faceprints did not match a faceprint in the database.

13. A method according to claim 12, further comprising:
storing the input regarding the identity of one or more faces in the photograph which faceprints did not match a faceprint in the database together with the previously unidentified faceprint in the database.

14. A method according to claim 13, further comprising:
accepting contact information about the person identified through accepting input; and
contacting the person to confirm their identity.

15. A system for categorizing each of several faces in a single digital image, said system comprising:
a database storing a plurality of faceprints, each associated with a person's identity;
a facial recognition system coupled to said database;
an input device coupled to said facial recognition system and being adapted to transmit a digital image containing a plurality of faces to said facial recognition system; and
an output device coupled to said facial recognition system and being adapted to display said digital image, wherein
said facial recognition system locates each of said plurality of faces in said digital image, creates a faceprint for each face located, compares the faceprints to said database of faceprints; and
the output device displays said digital image with a bounding shape associated with each face in said digital image, and an indication of whether or not the faceprint for the associated shape matched a faceprint in the database.

16. A system according to claim 15, wherein:
the output device displays a bounding shape of one color if the faceprint of the associated face matches a faceprint in the database and of a different color if it does not match.

17. A system according to claim 15, wherein:
the output device indicates a characteristic of the persons associated with faceprints which matched faceprints in the database.

18. A system according to claim 15, wherein:
said input device is adapted to accept input regarding the identity of one or more faces in the digital image which faceprints did not match a faceprint in the database.

19. A system according to claim 18, wherein:
said database is adapted to store the input regarding the identity of one or more faces in the digital image which faceprints did not match a faceprint in the database together with the previously unidentified faceprint in the database.

20. A system according to claim 19, further comprising:
a messaging system coupled to said database, said messaging system being adapted to accept contact information about the person identified through accepting input and to send a message to the person to confirm their identity.
